(19) United States
(12) Patent Application Publication
(10) Pub. No.: US 2009/0192926 A1
(43) Pub. Date: Jul. 30, 2009

(54) REAL-TIME PAYROLL

(75) Inventor: Tara L. Tarapata, North Andover, MA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 12/022,817

(22) Filed: Jan. 30, 2008

(51) Int. Cl. G06Q 10/00

(52) U.S. Cl. 705/32

(57) ABSTRACT

A system for compensating an employee before a payroll period is complete is presented. During operation, the system receives a request from the employee to be compensated before a payroll period is complete for uncompensated work which has been already performed. The system then determines whether the employee can be compensated for such uncompensated work. If so, the system determines the value of the uncompensated performed work and compensates the employee for the uncompensated performed work. The system also records the fact that the employee was compensated for the uncompensated performed work.

### BACKGROUND

### Related Art

The present invention relates to techniques for compensating employees for their work.

Employees are typically paid at fixed time intervals. For example, employees are typically paid twice a month or once every two weeks. Unfortunately, many employees live paycheck-to-paycheck. This problem is compounded by the fact that many employees also experience cash flow problems. For example, an employee may be paid twice a month, but the employee must pay bills near the end of their payroll cycle. Hence, the employee may not have sufficient funds to pay these bills. Although the employee can use check cashing services and paycheck advances from their employers, these services typically come at a price.

### SUMMARY

Some embodiments of the present invention provide a system for compensating an employee before a payroll period is complete. During operation, the system receives a request from the employee to be compensated before a payroll period is complete for uncompensated work which has been already performed. The system then determines whether the employee can be compensated for such uncompensated performed work. If so, the system determines the value of the uncompensated performed work and compensates the employee for the uncompensated performed work. The system also records the fact that the employee was compensated for the uncompensated performed work.

In some embodiments, while determining the value of the uncompensated performed work, the system determines whether the employee was compensated for work performed after a previous payroll period ended. If so, the system determines the value of the uncompensated work performed between a most-recent time for which the employee was compensated after the previous payroll period ended and the time when the request was received.

In some embodiments, if the employee was not compensated for work performed after the previous payroll period, the system determines whether the employee was compensated for work performed during the previous payroll period. If so, the system determines the value of the uncompensated work performed between the end of the previous payroll period and the time when the request was received.

In some embodiments, if the employee was not compensated for the work performed during the previous payroll period, the system determines whether the employee was compensated at a previous time. If so, the system determines the value of the uncompensated work performed between the previous time and the time when the request was received.

In some embodiments, if the employee was not compensated at a previous time, the system determines the value of the uncompensated work performed up to the time when the request was received.

In some embodiments, the system compensates the employee for the value of the uncompensated work performed during a present payroll period.

In some embodiments, while compensating the employee for the value of the uncompensated work performed during the present payroll period, the system determines whether the employee was compensated for work performed after a previous payroll period ended. If so, the system determines a value of the work performed between a most-recent time for which the employee was compensated after the previous payroll period ended and the end of the present payroll period. Next, the system compensates the employee for the value of the work performed between the most-recent time for which the employee was compensated after the previous payroll period ended and the end of the present payroll period. The system then records the fact that the employee was compensated for the value of the work performed between the most-recent time for which the employee was compensated after the previous payroll period ended and the end of the present payroll period.

In some embodiments, if the employee was not compensated for work performed after the previous payroll period ended, the system determines the value of the work performed between the end of the previous payroll period and the end of the present payroll period. Next, the system compensates the employee for the value of the work performed between the end of the previous payroll period and the end of the present payroll period. The system then records the fact that the employee was compensated for the work performed between the end of the previous payroll period and the end of the present payroll period.

In some embodiments, the system compensates the employee using one or more of: cash; stock; a check; a direct deposit into a bank account; and a deposit into a debit card account.

In some embodiments, the debit card account is associated with one or more of: the employee; and the employer.

In some embodiments, the debit card is restricted to being used to pay for specified classes of expenses.

In some embodiments, determining the value of the uncompensated work performed by the employee involves considering one or more of: the number of hours the employee has worked; the percentage of the payroll period that has elapsed; and the percentage of a project that was completed.

In some embodiments, if the employee cannot be compensated for the value of the uncompensated work performed, the system does not compensate the employee.

In some embodiments, while determining whether the employee can be compensated for the value of the uncompensated work performed, the system determines whether the employee is allowed to make a request to be compensated for the value of the uncompensated work performed. If so, the system determines whether available funds are greater than or equal to the value of the uncompensated work performed. If so, the system determines that the employee can be compensated for the value of the uncompensated work performed.

In some embodiments, if available funds are less than the value of the uncompensated work performed, the system determines that the employee cannot be completely compensated for the value of the uncompensated work performed.

In some embodiments, after determining that the employee cannot be completely compensated, the system does not compensate the employee.

In some embodiments, after determining that the employee cannot be compensated completely from available funds, the system partially compensates the employee using the available funds. The system then records the fact that the employee was compensated with a difference between the value of the uncompensated work performed and the available funds.

In some embodiments, after determining that the employee cannot be completely compensated from available funds, the system compensates the employee using a subset of the available funds. The system then records the fact that the employee was compensated with a difference between the value of the uncompensated work performed and the subset of the available funds.

In some embodiments, if the employee is not allowed to make a request to be compensated for the value of the uncompensated work performed, the system does not compensate the employee.

In some embodiments, while determining whether the employee can be compensated for the value of the uncompensated work performed, the system determines whether the number of requests the employee has made within a specified time period exceeds a specified maximum number of requests the employee can make within the specified time period. If so, the system determines that the employee cannot be compensated for the value of the uncompensated work performed. Otherwise, the system determines that the employee can be compensated for the value of the uncompensated work performed.

In some embodiments, while compensating the employee for the value of the uncompensated work performed, the system determines an amount to be withheld from the employee based on the value of the uncompensated work performed. The system then compensates the employee with a difference between the value of the uncompensated work performed and the amount to be withheld from the employee.

Some embodiments of the present invention provide an apparatus that compensates an employee before a payroll period is complete. The apparatus includes one or more of a receiving module, an analysis module, and a compensation module. The receiving module is configured to receive a request from the employee to be compensated for an uncompensated value of work performed by the employee before a payroll period is complete. The analysis module is configured to determine whether the employee can be compensated for the value of the uncompensated work performed. If the analysis module determines that the employee can be compensated for the value of the uncompensated work performed, the compensation module is configured to determine the value of the uncompensated work performed, compensate the employee for the value of the uncompensated work performed, and record the fact that the employee was compensated for the value of the uncompensated work performed.

Some embodiments of the present invention provide a system that processes requests on behalf of an employee to be compensated by an employer between payroll periods. During operation, the system sends to the employer a request to be compensated before a payroll period is complete for an uncompensated value of work performed by an employee before a payroll period is complete. In response to the request, the system allows the employer to determine whether the employee can be compensated for the value of the uncompensated work performed. If the employer determines that the employee can be compensated for the value of the uncompensated work performed, the system allows the employer to determine the value of the uncompensated work performed. The system then receives from the employer compensation for the value of the uncompensated work performed.

Some embodiments of the present invention provide a payroll system which includes a request module, a time-input module, a withholding-determination module, and a compensation module. The request module is configured to receive requests from employees to be compensated for work performed by the employee before a current payroll period is complete. The time-input module is configured to receive the amount of time the employees have worked. The withholding-determination module is configured to determine an amount to be withheld from an employee based on the value of the uncompensated work performed. The compensation module is configured to determine the uncompensated value the work performed and compensate employees with a difference between the value of the uncompensated work performed and the amount to be withheld from the employee as determined by the withholding-determination mechanism.

### BRIEF DESCRIPTION OF THE FIGURES

FIG. 1A presents a block diagram illustrating a computer system in accordance with an embodiment of the present invention.

FIG. 1B presents a block diagram of a payroll module in accordance with an embodiment of the present invention.

FIG. 2A presents a block diagram illustrating an exemplary process for compensating an employee in accordance with an embodiment of the present invention.

FIG. 2B presents a block diagram illustrating another exemplary process for compensating an employee in accordance with an embodiment of the present invention.

FIG. 3A presents a block diagram illustrating an exemplary process for compensating an employee using a paycheck service in accordance with an embodiment of the present invention.

FIG. 3B presents a block diagram illustrating another exemplary process for compensating an employee using a paycheck service in accordance with an embodiment of the present invention.

FIG. 4 presents a flow chart illustrating the process for compensating an employee in accordance with an embodiment of the present invention.

FIG. 5 presents a flow chart illustrating the process for determining an uncompensated value of work performed in accordance with an embodiment of the present invention.

FIG. 6 presents a flow chart illustrating the process for compensating an employee for work performed during a present payroll period in accordance with an embodiment of the present invention.

FIG. 7 presents a flow chart illustrating the process for determining whether an employee can be compensated for the value of the uncompensated work performed in accordance with an embodiment of the present invention.

FIG. 8 presents a flow chart illustrating another process for determining whether an employee can be compensated for the value of the uncompensated work performed in accordance with an embodiment of the present invention.

FIG. 9 presents a flow chart illustrating another process for compensating an employee for the value of the uncompensated work performed in accordance with an embodiment of the present invention.

FIG. 10 presents a flow chart illustrating a process for requesting compensation for an employee from an employer in accordance with an embodiment of the present invention.

FIG. 11 presents a block diagram of an exemplary payroll system in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description can be embodied as code, data structures, and/or data, which can be stored on a computer-readable storage medium as described above. When a computer system reads and executes the code and/or data stored on the computer-readable storage medium, the computer system performs the methods and processes embodied as code, data structures, and/or data that are stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Computer System

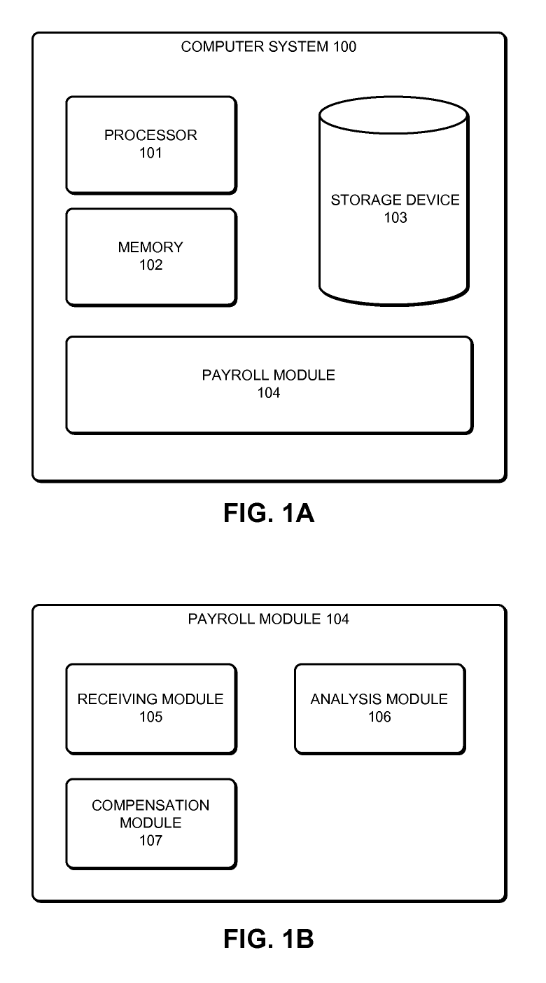

FIG. 1A presents a block diagram illustrating a computer system 100 in accordance with an embodiment of the present invention. Computer system 100 includes processor 101, memory 102, storage device 103, and payroll module 104.

Processor 101 can generally include any type of processor, including, but not limited to, a microprocessor, a mainframe computer, a digital signal processor, a personal organizer, a device controller and a computational engine within an appliance. Memory 102 can include any type of memory, including but not limited to, dynamic random access memory (DRAM), static random access memory (SRAM), flash memory, read only memory (ROM), and any other type of memory now known or later developed. Storage device 103 can include any type of non-volatile storage device that can be coupled to a computer system. This includes, but is not limited to, magnetic, optical, and magneto-optical storage devices, as well as storage devices based on flash memory and/or battery-backed up memory.

In some embodiments of the present invention, payroll module 104 is separate from computer system 100. Note that payroll module 104 is described in more detail below with reference to FIG. 1B.

FIG. 1B presents a block diagram of payroll module 104 in accordance with an embodiment of the present invention. Payroll module 104 includes one or more of receiving module 105, an analysis module 106, and a compensation module 107. Receiving module 105 is configured to receive a request from the employee to be compensated for an uncompensated value of work performed by the employee. Analysis module 106 is configured to determine whether the employee can be compensated for the value of the uncompensated work performed. If analysis module 106 determines that the employee can be compensated for the value of the uncompensated work performed, compensation module 107 is configured to determine the value of the uncompensated work performed and then to compensate the employee for the value of the uncompensated work performed. Compensation module 107 also records the fact that the employee was compensated for the value of the uncompensated work performed.

In some embodiments, one or more of receiving module 105, an analysis module 106, and a compensation module 107 are included in one or more integrated circuit (IC) chips. For example, these IC chips can include, but are not limited to, application-specific integrated circuit (ASIC) chips, field-programmable gate arrays (FPGAs), and other programmable-logic devices now known or later developed.

### Exemplary Processes for Compensating Employees

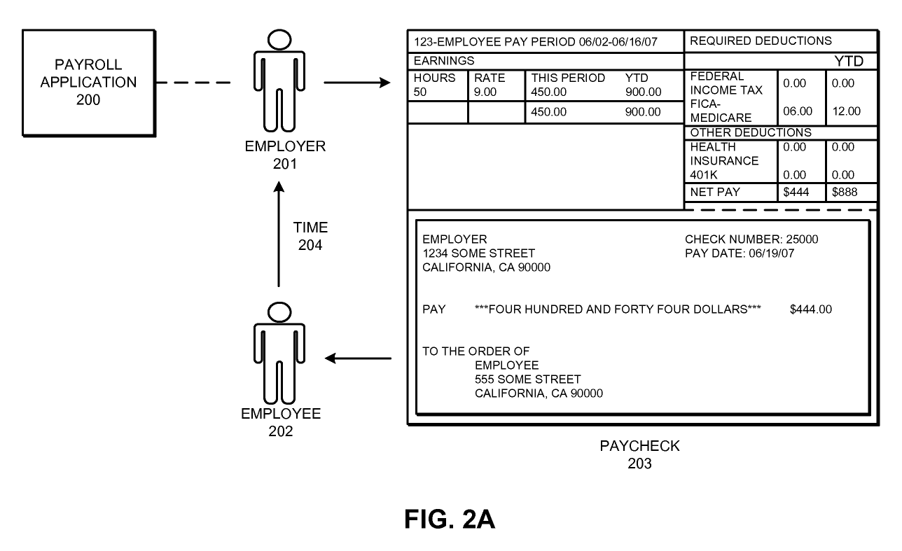

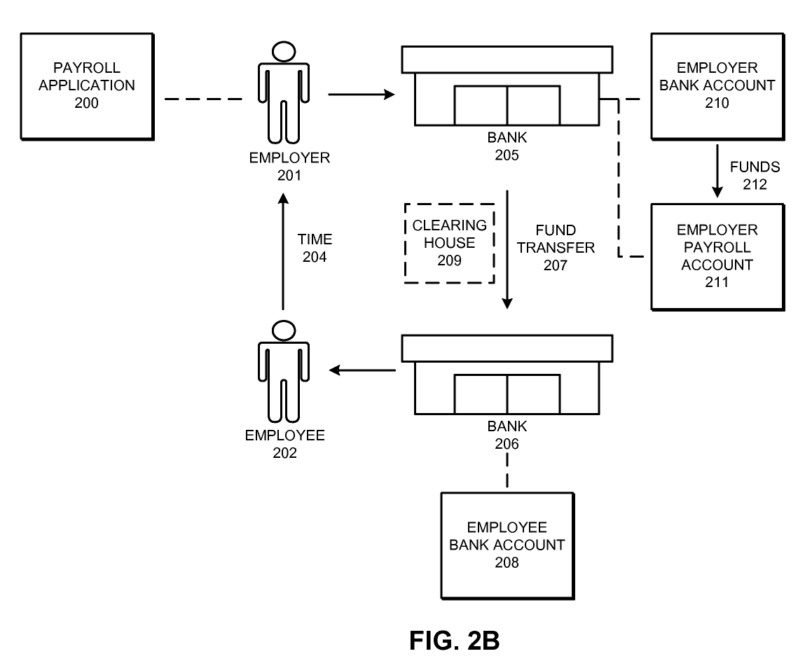

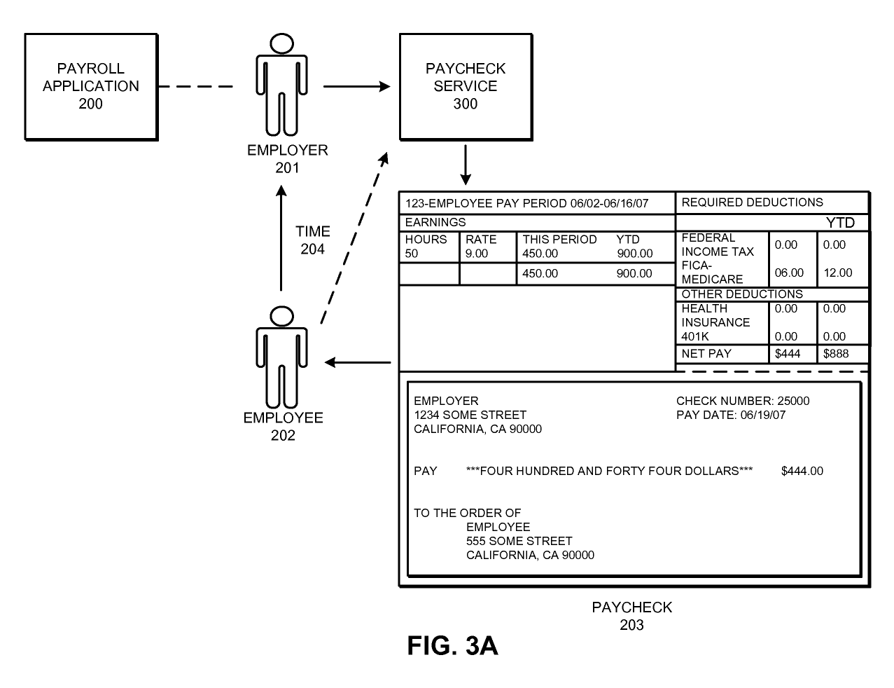

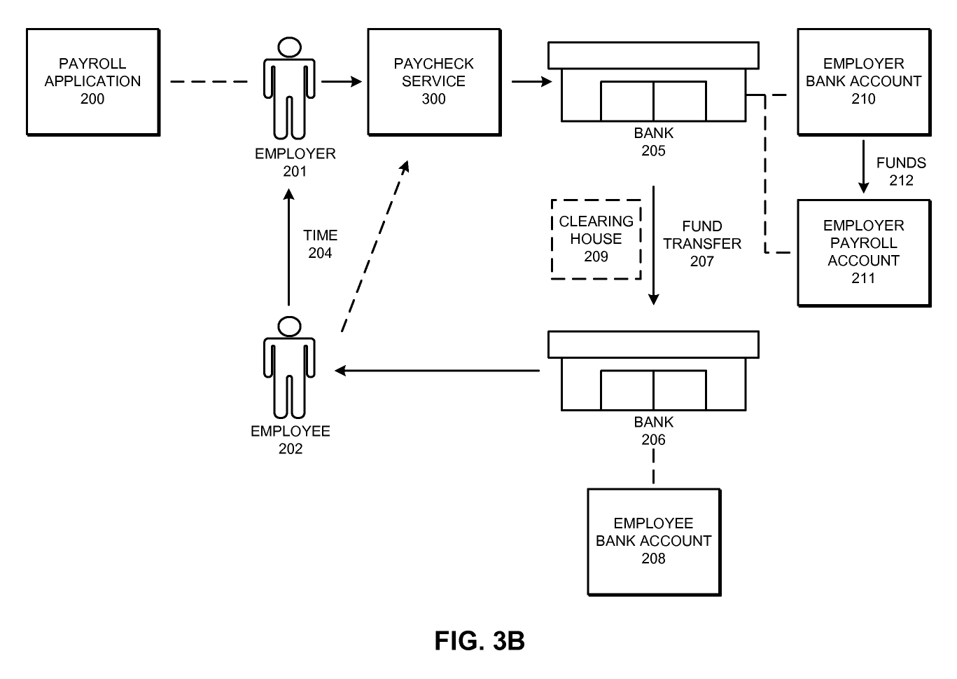

FIGS. 2A-3B illustrate several exemplary processes for compensating employees. FIG. 2A presents a block diagram illustrating an exemplary process of compensating employee 202 in accordance with an embodiment of the present invention. In FIG. 2A, employee 202 submits time 204 to employer 201. In some embodiments, time 204 can be reported as the number of hours worked and/or the percentage of the payroll period worked.

In some embodiments, employer 201 generates paycheck 203 for employee 202 based on time 204. For example, paycheck 203 can include deductions/withholdings (e.g., for taxes, Social Security, retirement accounts, disability, etc.), the number of hours worked, the hourly rate, the net pay, the gross pay, and a check. In some embodiments, employer 201 uses payroll application 200 to generate a paycheck 203 for employee 202.

FIG. 2B presents a block diagram illustrating an exemplary process for compensating employee 202 in accordance with an embodiment of the present invention. In FIG. 2B, employee 202 submits time 204 to employer 201.

In some embodiments, employer 201 initiates fund transfer 207 from employer payroll account 211 at bank 205 to employee bank account 208 at bank 206. In some embodiments, employer 201 uses payroll application 200 to initiate fund transfer 207 from employer bank account 211 to employee bank account 208. Note that the funds transferred from employer 201 to employee 202 typically include the payroll deductions/withholdings as discussed above.

In some embodiments, fund transfer 207 is an electronic fund transfer performed using clearinghouse 209. For example, clearinghouse 209 can be an automated clearinghouse (ACH).

In some embodiments, prior to initiating fund transfer 207, employer 201 first transfers funds 212 from employer bank account 210 to employer payroll account 211 so that employer 201 has sufficient funds to compensate employee 202.

Note that although employer bank account 210 and 211 are illustrated as both being at bank 205, these bank accounts can be maintained at separate banks. Similarly, employee bank account 208 can be maintained at any bank, including bank 205.

FIG. 3A presents a block diagram illustrating an exemplary process for compensating an employee using a paycheck service in accordance with an embodiment of the present invention. Note that FIG. 3A is similar to FIG. 2A, thus only the differences are described. In some embodiments, employee 202 submits time 204 to employer 201. In some embodiments, employer 201 uses paycheck service 300 to generate paycheck 203 for employee 202 based on time 204. In some embodiments, employer 201 uses payroll application 200 to send time 204 to paycheck service 300.

In some embodiments, employee 202 submits time 204 to paycheck service 300. Paycheck service 300 then generates paycheck 203 for employee 202 based on time 204 on behalf of employer 201.

FIG. 3B presents a block diagram illustrating an exemplary process for compensating an employee using a paycheck service in accordance with an embodiment of the present invention. Note that FIG. 3B is similar to FIG. 2B, thus only the differences are described. In FIG. 3B, employee 202 submits time 204 to employer 201. In some embodiments, employer 201 uses paycheck service 300 to initiate fund transfer 207 from employer payroll account 211 at bank 205 to employee bank account 208 at bank 206. In some embodiments, employer 201 uses payroll application 200 to send time 204 to paycheck service 300.

In some embodiments, employee 202 submits time 204 to paycheck service 300. Paycheck service 300 then initiates fund transfer 207 for employee 202 based on time 204 on behalf of employer 201.

In some embodiments, prior to initiating fund transfer 207, paycheck service 300 transfers funds 212 from employer bank account 210 to employer payroll account 211 on behalf of employer 201.

### Real-Time Payroll

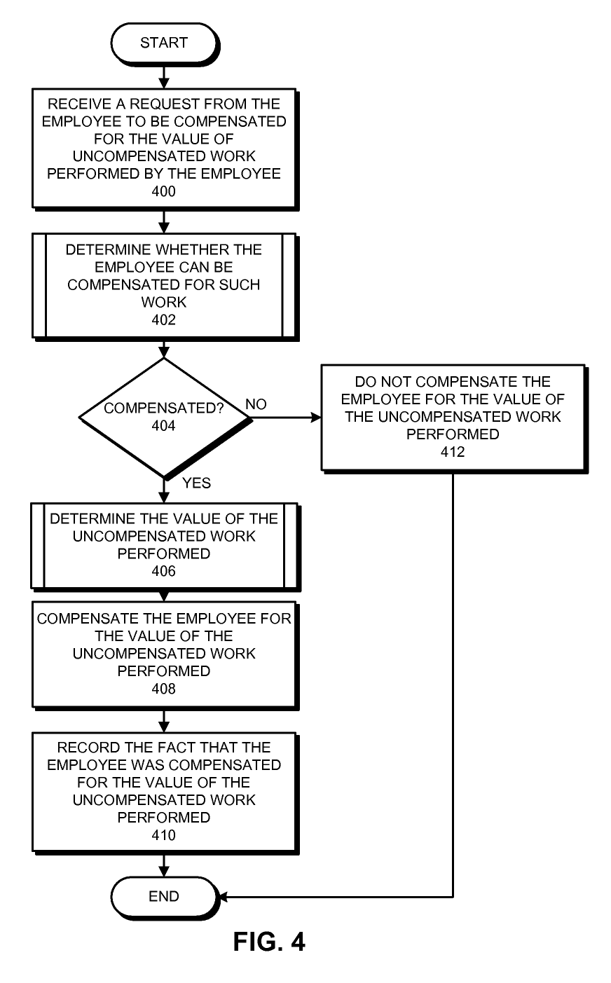

In some embodiments, a real-time payroll system compensates employees for work that the employees have already performed. In these embodiments, the payroll system processes payroll when requested by the employer and/or employee in addition to or in lieu of processing payroll at specified payroll intervals. Hence, employers can pay the employee for time actually worked at any given time and the employees can access the money they need when they require it. FIGS. 4-11 describe embodiments of a real-time payroll system in more detail.

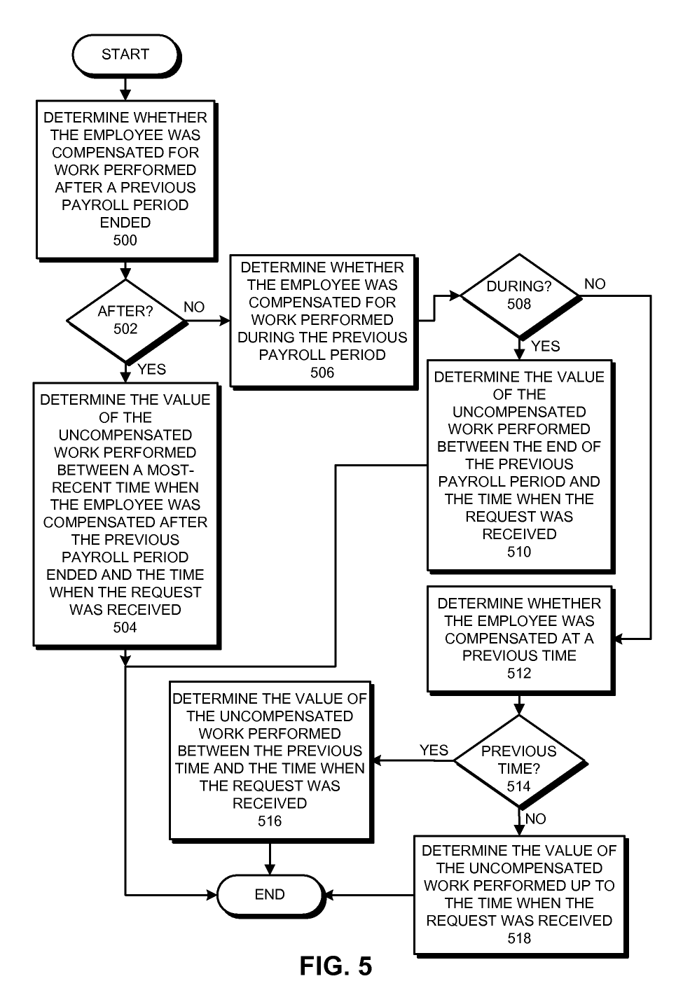

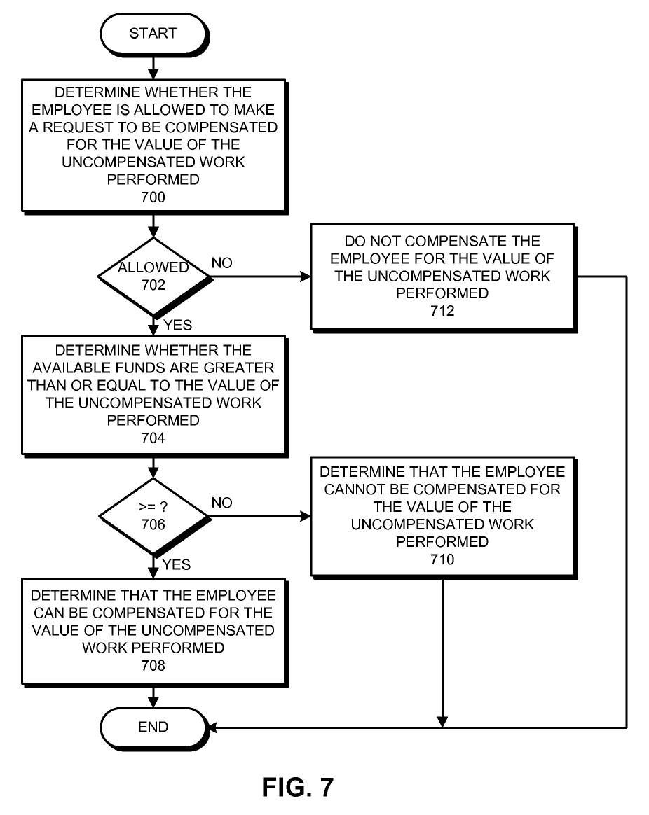

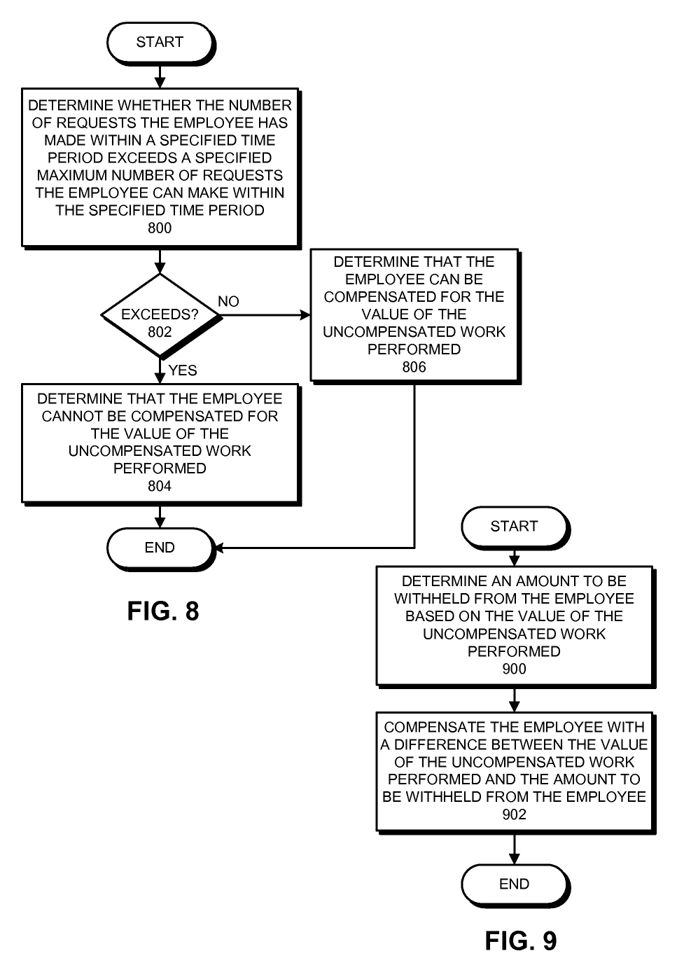

FIG. 4 presents a flow chart illustrating the process for compensating an employee in accordance with an embodiment of the present invention. The process begins when the system receives a request from the employee to be compensated for an uncompensated value of work performed by the employee (step 400). The system then determines whether the employee can be compensated for the value of the uncompensated work performed (step 402). Step 402 is described in more detail with reference to FIGS. 7-8 below. If so (step 404, yes), the system determines the value of the uncompensated work performed (step 406). Step 406 is described in more detail with reference to FIG. 5 below. Next, the system compensates the employee for the value of the uncompensated work performed (step 408). The system then notes that the employee was compensated for the value of the uncompensated work performed (step 410). If the system determines that the employee cannot be compensated for the value of the uncompensated work performed (step 404, no), the system does not compensate the employee for the value of the uncompensated work performed (step 412).

In some embodiments, the system compensates the employee using one or more of: cash; stock; a check; a direct deposit into a bank account associated with the employee; and a deposit into a debit card account.

In some embodiments, the debit card account is associated with one or more of: the employee; and the employer. For example, an employer can compensate an employee by depositing funds into a debit card account. The employee can then use the debit card account to purchase goods and services, or to pay off debts.

In some embodiments, the debit card is restricted to being used to pay for specified classes of expenses. For example, the debit card can be restricted so that the debit card can only be used to pay utility bills.

In some embodiments, the value of the uncompensated work performed by the employee is based on one or more of: the number of hours the employee has worked; the percentage of the payroll period that has elapsed; and the percentage of a project that was completed.

FIG. 5 presents a flow chart illustrating the process for determining an uncompensated value of work performed in accordance with an embodiment of the present invention. The process begins when the system determines whether the employee was compensated for work performed after a previous payroll period ended (step 500). If so (step 502, yes), the system determines the value of the uncompensated work performed between a most-recent time when the employee was compensated after the previous payroll period ended and the time when the request was received (step 504). For example, if an employee submitted two requests after the previous payroll period, both of which were fulfilled, the compensation for the present request is calculated based on the amount of work performed since the second (i.e., the latest) request that was fulfilled.

If the employee was not compensated for work performed after the previous payroll period (step 502, no), the system determines whether the employee was compensated for work performed during the previous payroll period (step 506). If so (step 508, yes), the system determines the value of the uncompensated work performed between the end of the previous payroll period and the time when the request was received (step 510).

If the employee was not compensated for the work performed during the previous payroll period (step 508, no), the system determines whether the employee was compensated at a previous time (step 512). If so (step 514, yes), the system determines the value of the uncompensated work performed between the previous time and the time when the request was received (step 516). For example, this case can occur when the employer compensated an employee at a time prior to the end of the previous payroll period, but did not compensate the employee at the end of the previous payroll period and did not receive a previous request from the employee to be compensated for the value of the uncompensated work performed. If the employee was not compensated at a previous time (step 514, no), the system determines the value of the uncompensated work performed up to the time when the request was received (step 518). For example, this case can occur when the employee has never been paid by the employer (e.g., a new employee who was not compensated at the end of the previous payroll period).

In some embodiments, even if an employee makes a request to be compensated for the value of the uncompensated work performed by the employee, the employer may decide that certain conditions exist so that the employee cannot be compensated for the value of the uncompensated work performed when the request is made. FIG. 7 presents a flow chart illustrating the process for determining whether an employee can be compensated for the value of the uncompensated work performed in accordance with an embodiment of the present invention. The process begins when the system determines whether the employee is allowed to make a request to be compensated for the value of the uncompensated work performed (step 700). If so (step 702, yes), the system determines whether the available funds are greater than or equal to the value of the uncompensated work performed (step 704). If so (step 706, yes), the system determines that the employee can be compensated for the value of the uncompensated work performed (step 708).

If the available funds are less than the value of the uncompensated work performed (step 706, no), the system determines that the employee cannot be completely compensated for the value of the uncompensated work performed (step 710).

In some embodiments, after determining that the employee cannot be compensated from available funds for the value of the uncompensated work performed, the system does not compensate the employee for the value of the uncompensated work performed. Note that although the employee is not compensated for work performed in response to the request, the employee can be compensated at a later time for the work performed when more funds become available. For example, the employee can be compensated at the end of a normal payroll period.

In some embodiments, after determining that the employee cannot be completely compensated for the value of the uncompensated work performed from available funds, the system compensates the employee using the available funds and notes that the employee was compensated with a difference of the value of the uncompensated work performed and the available funds. In these embodiments, the employee is partially compensated for the work performed and can be compensated with the deficient amount at a later time when more funds are available.

In some embodiments, after determining that the employee cannot be completely compensated for the value of the uncompensated work performed from available funds, the system compensates the employee using a subset of the available funds and notes that the employee was compensated with a difference between the value of the uncompensated work performed and the subset of the available funds. In these embodiments, the employee is partially compensated for the work performed and can be compensated with the deficient amount at a later time when more funds are available.

Returning to FIG. 7, if the employee is not allowed to make a request to be compensated for the value of the uncompensated work performed (step 702, no), the system does not compensate the employee for the value of the uncompensated work performed (step 712). Note that although the employee is not compensated in response to the request, the employee can be compensated at a later time for the work performed when more funds become available. For example, the employee can be compensated at the end of a normal payroll period.

In some embodiments, an employer may set a limit on the number of requests an employee can make within a given time period. FIG. 8 presents a flow chart illustrating another process for determining whether an employee can be compensated for the value of the uncompensated work performed in accordance with an embodiment of the present invention. The process begins when the system determines whether the number of requests the employee has made within a specified time period exceeds a specified number of maximum requests the employee can make within the specified time period (step 800). If so (step 802, yes), the system determines that the employee cannot be compensated for the value of the uncompensated work performed (step 804). Otherwise (step 802, no), the system determines that the employee can be compensated for the value of the uncompensated work performed (step 806).

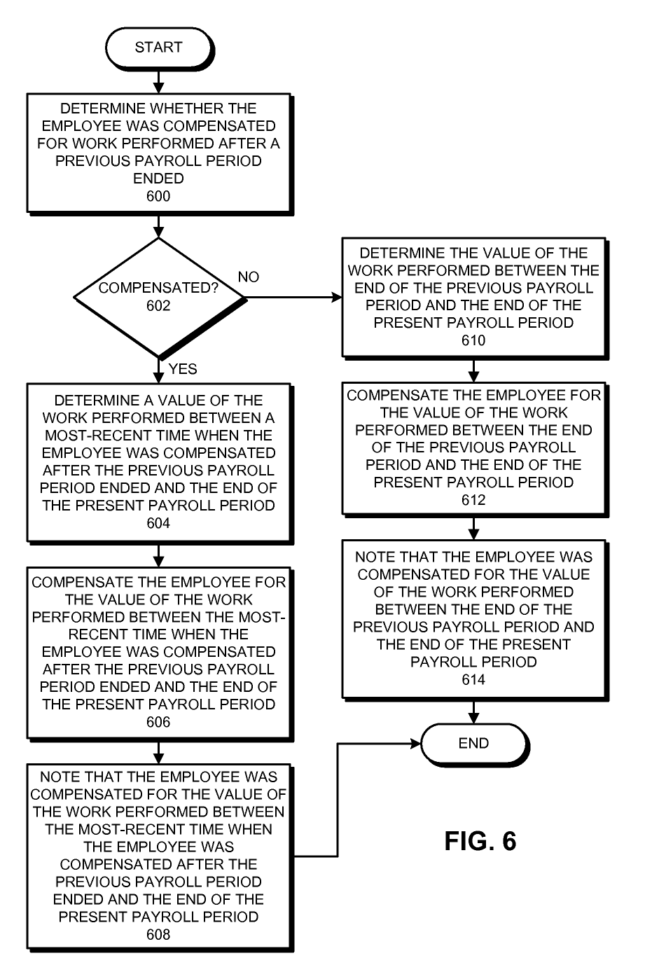

In some embodiments, employers perform payroll operations both at specified payroll periods and in response to an employee's request to be compensated for the value of the uncompensated work performed (e.g., typically in between payroll dates). Hence, when the end of a specified payroll period arrives, any compensation already distributed to employees for work performed is taken into account when determining the amount of additional compensation to be distributed to the employee at the end of the specified payroll period. FIG. 6 presents a flow chart illustrating the process for compensating an employee for work performed during a present payroll period in accordance with an embodiment of the present invention. The process begins when the system determines whether the employee was compensated for work performed after a previous payroll period ended (step 600). If so (step 602, yes), the system determines a value of the work performed between a most-recent time when the employee was compensated after the previous payroll period ended and the end of the present payroll period (step 604). Next, the system compensates the employee for the value of the work performed between the most-recent time when the employee was compensated after the previous payroll period ended and the end of the present payroll period (step 606). The system then notes that the employee was compensated for the value of the work performed between the most-recent time when the employee was compensated after the previous payroll period ended and the end of the present payroll period (step 608).

If the employee was not compensated for work performed after the previous payroll period ended (step 602, no), the system determines the value of the work performed between the end of the previous payroll period and the end of the present payroll period (step 610). Next, the system compensates the employee for the value of the work performed between the end of the previous payroll period and the end of the present payroll period (step 612). The system then notes that the employee was compensated for the value of the work performed between the end of the previous payroll period and the end of the present payroll period (step 614).

FIG. 9 presents a flow chart illustrating another process for compensating an employee for the value of the uncompensated work performed in accordance with an embodiment of the present invention. The process begins when the system determines an amount to be withheld from the employee based on the value of the uncompensated work performed (step 900). The system then compensates the employee with a difference between the value of the uncompensated work performed and the amount to be withheld from the employee (step 902).

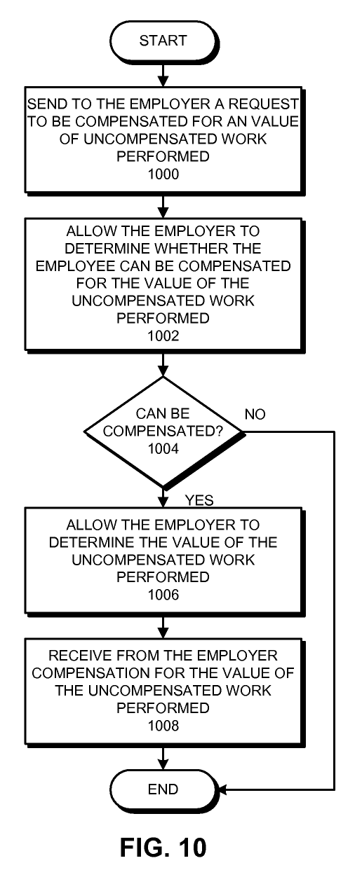

FIG. 10 presents a flow chart illustrating another process for requesting compensation for an employee from an employer in accordance with an embodiment of the present invention. The process begins when the system sends to the employer a request to be compensated for an uncompensated value of work performed (step 1000). In response to the request, the system allows the employer to determine whether the employee can be compensated for the value of the uncompensated work performed (step 1002). If the employer determines that the employee can be compensated for the value of the uncompensated work performed (step 1004, yes), the system allows the employer to determine the value of the uncompensated work performed (step 1006). The system then receives from the employer compensation for the value of the uncompensated work performed (step 1008).

### Exemplary Payroll System

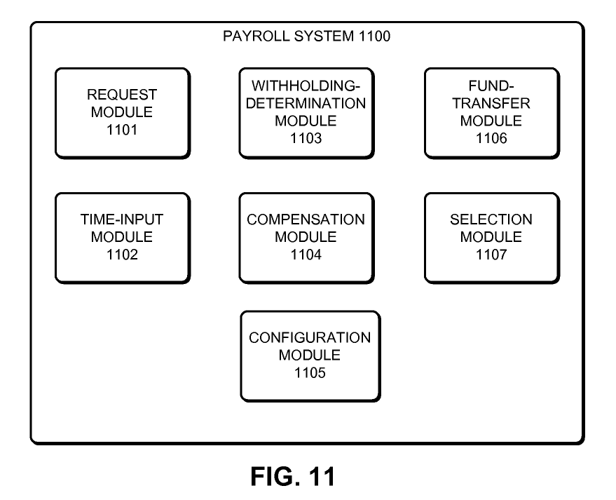

FIG. 11 presents a block diagram of an exemplary payroll system 1100 in accordance with an embodiment of the present invention. Payroll system 1100 includes one or more of request module 1101, time-input module 1102, withholding-determination module 1103, compensation module 1104, configuration module 1105, fund-transfer module 1106, and selection module 1107.

Request module 1101 is configured to receive requests from employees to be compensated for an uncompensated value of work performed by the employee. Time-input module 1102 is configured to receive the amount of time employees have worked. Withholding-determination module 1103 is configured to determine an amount to be withheld from the employee based on the value of the uncompensated work performed. Compensation module 1104 is configured to: determine the uncompensated value the work performed; and compensate employees with a difference between the value of the uncompensated work performed and the amount to be withheld from the employee determined by withholding-determination module 1103.

Fund-transfer module 1106 is configured to initiate an electronic funds transfer from a bank account associated with the employer to a payroll account associated with the employer. Selection module 1107 is configured to select a subset of employees to be compensated, wherein the subset of employees can include one or more of: employees who have requested to be compensated for the value of the uncompensated work performed; and employees who have not requested to be compensated for the value of the uncompensated work performed.

Configuration module 1105 is configured to receive one or more of: a subset of employees who are allowed to make requests to be compensated for the value of the uncompensated work performed; a frequency at which employees can make requests to be compensated for the value of the uncompensated work performed; the amount of funds available to compensate employees who have requested to be compensated for the value of the uncompensated work performed; a maximum amount that employees can be compensated for the value of the uncompensated work performed; and one or more forms of compensation in which employees can be compensated for the value of the uncompensated work performed.

In some embodiments, one or more of request module 1101, time-input module 1102, withholding-determination module 1103, compensation module 1104, configuration module 1105, fund-transfer module 1106, and selection module 1107 are included in one or more integrated circuit (IC) chips. For example, these IC chips can include, but are not limited to, application-specific integrated circuit (ASIC) chips, field-programmable gate arrays (FPGAs), and other programmable-logic devices now known or later developed.

In some embodiments, if the employee is compensated using a direct deposit transfer, compensation module 1104 is configured to initiate an electronic funds transfer from a payroll account associated with the employer to a bank account associated with the employee.

In some embodiments, if the employee is compensated using a physical paycheck, compensation module 1104 is configured to generate the physical paycheck.

In some embodiments, if the employee is compensated using a debit card, compensation module 1104 is configured to initiate an electronic funds transfer from a payroll account associated with the employer to a debit card account.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for compensating an employee before a payroll period is complete, comprising:
receiving a request from the employee to be compensated for a value of uncompensated work performed by the employee before a payroll period is complete;
determining whether the employee can be compensated for such work;
if so,
determining the value of the uncompensated work performed;
compensating the employee for the determined value; and
recording the fact that the employee was compensated for the value of the uncompensated work performed.

2. The method of claim 1, wherein determining the value of the uncompensated work performed involves:
determining whether the employee was compensated for work performed after a previous payroll period ended; and
if so, determining the value of the uncompensated work performed between a most-recent time for which the employee was compensated after the previous payroll period ended and the time when the request was received.

3. The method of claim 2, wherein if the employee was not compensated for work performed after the previous payroll period, the method further comprises:
determining whether the employee was compensated for work performed during the previous payroll period; and
if so, determining the value of the uncompensated work performed between the end of the previous payroll period and the time when the request was received.

4. The method of claim 3, wherein if the employee was not compensated for the work performed during the previous payroll period, the method further comprises:
determining whether the employee was compensated at a previous time; and
if so, determining the value of the uncompensated work performed between the previous time and the time when the request was received.

5. The method of claim 4, wherein if the employee was not compensated at a previous time, the method further comprises determining the value of the uncompensated work performed up to the time when the request was received.

6. The method of claim 1, further comprising compensating the employee for the value of the uncompensated work performed during a present payroll period.

7. The method of claim 6, wherein compensating the employee for the value of the uncompensated work performed during the present payroll period involves:
determining whether the employee was compensated for work performed after a previous payroll period ended;
if so,
determining a value of the work performed between a most-recent time for which the employee was compensated after the previous payroll period ended and the end of the present payroll period;
compensating the employee for the value of the work performed between the most-recent time for which the employee was compensated after the previous payroll period ended and the end of the present payroll period; and
recording the fact that the employee was compensated for the value of the work performed between the most-recent time for which the employee was compensated after the previous payroll period ended and the end of the present payroll period.

8. The method of claim 7, wherein if the employee was not compensated for work performed after the previous payroll period ended, the method further comprises:
determining the value of the work performed between the end of the previous payroll period and the end of the present payroll period;
compensating the employee for the value of the work performed between the end of the previous payroll period and the end of the present payroll period; and
recording the fact that the employee was compensated for the value of the work performed between the end of the previous payroll period and the end of the present payroll period.

9. The method of claim 1, wherein compensating the employee can involve compensating the employee using one or more of:
cash;
stock;
a check;
a direct deposit into a bank account; and
a deposit into a debit card account.

10. The method of claim 9, wherein the debit card account is associated with one or more of:
the employee; and
the employer.

11. The method of claim 9, wherein the debit card is restricted to being used to pay for specified classes of expenses.

12. The method of claim 1, wherein determining the value of the uncompensated work performed by the employee involves one or more of:
the number of hours the employee has worked;
the percentage of the payroll period that has elapsed; and
the percentage of a project that was completed.

13. The method of claim 1, wherein if the employee cannot be compensated for the value of the uncompensated work performed, the method further comprises not compensating the employee for the value of the uncompensated work performed.

14. The method of claim 1, wherein determining whether the employee can be compensated for the value of the uncompensated work performed involves:
determining whether the employee is allowed to make a request to be compensated for the value of the uncompensated work performed;
if so, determining whether the available funds are greater than or equal to the value of the uncompensated work performed; and
if so, determining that the employee can be compensated for the value of the uncompensated work performed.

15. The method of claim 14, wherein if the available funds are less than the value of the uncompensated work performed, the method further comprises determining that the employee cannot be completely compensated for the value of the uncompensated work performed.

16. The method of claim 15, wherein after determining that the employee cannot be completely compensated, the method further comprises not compensating the employee for the value of the uncompensated work performed.

17. The method of claim 15, wherein after determining that the employee cannot be completely compensated, the method further comprises:
compensating the employee using the available funds; and
recording the fact that the employee was compensated with a difference between the value of the uncompensated work performed and the available funds.

18. The method of claim 15, wherein after determining that the employee cannot be completely compensated, the method further comprises:
compensating the employee using a subset of the available funds; and
recording the fact that the employee was compensated with a difference between the value of the uncompensated work performed and the subset of the available funds.

19. The method of claim 14, wherein if the employee is not allowed to make a request to be compensated for the value of the uncompensated work performed, the method further comprises not compensating the employee.

20. The method of claim 1, wherein determining whether the employee can be compensated for the value of the uncompensated work performed involves:
determining whether the number of requests the employee has made within a specified time period exceeds a specified maximum number of requests the employee can make within the specified time period;
if so, determining that the employee cannot be compensated for the value of the uncompensated work performed; and
otherwise, determining that the employee can be compensated for the value of the uncompensated work performed.

21. The method of claim 1, wherein compensating the employee for the value of the uncompensated work performed involves:
determining an amount to be withheld from the employee based on the value of the uncompensated work performed; and
compensating the employee with a difference between the value of the uncompensated work performed and the amount to be withheld from the employee.

22. A computer-readable storage medium storing instructions that when executed by a computer cause the computer to perform a method for compensating an employee before a payroll period is complete, wherein the method comprises:
receiving a request from the employee to be compensated for a value of uncompensated work performed by the employee before the payroll period is complete;
determining whether the employee can be compensated for such work;
if so,
determining the value of the uncompensated work performed;
compensating the employee for the determined value; and
recording the fact that the employee was compensated for the value of the uncompensated work performed.

23. The computer-readable storage medium of claim 22, wherein determining the value of the uncompensated work performed involves:
determining whether the employee was compensated for work performed after a previous payroll period ended; and
if so, determining the value of the uncompensated work performed between a most-recent time for which the employee was compensated after the previous payroll period ended and the time when the request was received.

24. The computer-readable storage medium of claim 23, wherein if the employee was not compensated for work performed after the previous payroll period, the method further comprises:
determining whether the employee was compensated for work performed during the previous payroll period; and
if so, determining the value of the uncompensated work performed between the end of the previous payroll period and the time when the request was received.

25. The computer-readable storage medium of claim 24, wherein if the employee was not compensated for the work performed during the previous payroll period, the method further comprises:
determining whether the employee was compensated at a previous time; and
if so, determining the value of the uncompensated work performed between the previous time and the time when the request was received.

26. The computer-readable storage medium of claim 25, wherein if the employee was not compensated at a previous time, the method further comprises determining the value of the uncompensated work performed up to the time when the request was received.

27. The computer-readable storage medium of claim 22, further comprising compensating the employee for the value of the uncompensated work performed during a present payroll period.

28. The computer-readable storage medium of claim 27, wherein compensating the employee for the value of the uncompensated work performed during the present payroll period involves:
determining whether the employee was compensated for work performed after a previous payroll period ended;
if so,
determining a value of the work performed between a most-recent time for which the employee was compensated after the previous payroll period ended and the end of the present payroll period;
compensating the employee for the value of the work performed between the most-recent time for which the employee was compensated after the previous payroll period ended and the end of the present payroll period; and
noting that the employee was compensated for the value of the work performed between the most-recent time for which the employee was compensated after the previous payroll period ended and the end of the present payroll period.

29. The computer-readable storage medium of claim 28, wherein if the employee was not compensated for work performed after the previous payroll period ended, the method further comprises:
determining the value of the work performed between the end of the previous payroll period and the end of the present payroll period;
compensating the employee for the value of the work performed between the end of the previous payroll period and the end of the present payroll period; and
recording the fact that the employee was compensated for the value of the work performed between the end of the previous payroll period and the end of the present payroll period.

30. The computer-readable storage medium of claim 22, wherein compensating the employee can involve compensating the employee using one or more of:
cash;
stock;
a check;
a direct deposit into a bank account; and
a deposit into a debit card account.

31. The computer-readable storage medium of claim 30, wherein the debit card account is associated with one or more of:
the employee; and
the employer.

32. The computer-readable storage medium of claim 30, wherein the debit card is restricted to being used to pay for specified classes of expenses.

33. The computer-readable storage medium of claim 22, wherein determining the value of the uncompensated work performed by the employee involves one or more of:
the number of hours the employee has worked;
the percentage of the payroll period that has elapsed; and
the percentage of a project that was completed.

34. The computer-readable storage medium of claim 22, wherein if the employee cannot be compensated for the value of the uncompensated work performed, the method further comprises not compensating the employee for the value of the uncompensated work performed.

35. The computer-readable storage medium of claim 22, wherein determining whether the employee can be compensated for the value of the uncompensated work performed involves:
determining whether the number of requests the employee has made within a specified time period exceeds a specified maximum number of requests the employee can make within the specified time period;
if so, determining that the employee cannot be compensated for the value of the uncompensated work performed; and
otherwise, determining that the employee can be compensated for the value of the uncompensated work performed.

36. The computer-readable storage medium of claim 22, wherein compensating the employee for the value of the uncompensated work performed involves:
determining an amount to be withheld from the employee based on the value of the uncompensated work performed; and
compensating the employee with a difference between the value of the uncompensated work performed and the amount to be withheld from the employee.

37. An apparatus that compensates an employee before a payroll period is complete, comprising:
a receiving mechanism configured to receive a request from the employee to be compensated for a value of uncompensated work performed by the employee before a payroll period is complete;
an analysis mechanism configured to determine whether the employee can be compensated for such work;
a compensation mechanism, wherein if the analysis mechanism determines that the employee can be compensated for the value of the uncompensated work performed, the compensation mechanism is configured to:
determine the value of the uncompensated work performed;
compensate the employee for the determined value; and
record the fact that the employee was compensated for the value of the uncompensated work performed.

38. A method for requesting compensation for an employee from an employer before a payroll period is complete, comprising:
sending to the employer a request to be compensated for an uncompensated value of work performed before a payroll period is complete;
in response to the request, allowing the employer to determine whether the employee can be compensated for the value of the uncompensated work performed;
if the employer determines that the employee can be compensated for the value of the uncompensated work performed,
allowing the employer to determine the value of the uncompensated work performed; and
receiving from the employer compensation for the determined value.

39. The method of claim 38, wherein prior to sending to the employer the request to be compensated for the value of the uncompensated work performed, the method further comprises periodically submitting to the employer the number of hours the employee has worked.

40. A payroll system, comprising:
a request mechanism configured to receive requests from employees to be compensated for an uncompensated value of work performed by the employee before a payroll period is complete;
a time-input mechanism configured to receive the amount of time employees have worked;
a withholding-determination mechanism configured to determine an amount to be withheld from the employee based on the value of the uncompensated work performed;
a compensation mechanism configured to:
determine the uncompensated value the work performed; and
compensate employees with a difference of the value of the uncompensated work performed and the amount to be withheld from the employee determined by the withholding-determination mechanism.

41. The payroll system of claim 40, wherein if the employee is compensated using a direct deposit transfer, the compensation mechanism is configured to initiate an electronic funds transfer from a payroll account associated with the employer to a bank account associated with the employee.

42. The payroll system of claim 40, wherein if the employee is compensated using a physical paycheck, the compensation mechanism is configured to generate the physical paycheck.

43. The payroll system of claim 40, wherein if the employee is compensated using a debit card, the compensation mechanism is configured to initiate an electronic funds transfer from a payroll account associated with the employer to a debit card account.

44. The payroll system of claim 40, further comprising a funds-transfer mechanism configured to initiate an electronic funds transfer from a bank account associated with the employer to a payroll account associated with the employer.

45. The payroll system of claim 40, further comprising a selection mechanism configured to select a subset of employees to be compensated, wherein the subset of employees can include one or more of:
employees who have requested to be compensated for the value of the uncompensated work performed; and
employees who have not requested to be compensated for the value of the uncompensated work performed.

46. The payroll system of claim 40, further comprising a configuration mechanism configured to receive one or more of:
a subset of employees who are allowed to make requests to be compensated for the value of the uncompensated work performed;
a frequency at which employees can make requests to be compensated for the value of the uncompensated work performed;
the amount of funds available to compensate employees who have requested to be compensated for the value of the uncompensated work performed;
a maximum amount that employees can be compensated for the value of the uncompensated work performed; and
one or more forms of compensation in which employees can be compensated for the value of the uncompensated work performed.
